(19) United States
(12) Patent Application Publication
(10) Pub. No.: US 2026/0303179 A1
(43) Pub. Date: Oct. 1, 2026

(54) COMMUNICATION DEVICES AND METHODS

(71) Applicant: Sony Group Corporation, Tokyo (JP)

(72) Inventors: Dana CIOCHINA-KAR, Stuttgart (DE); Gianmarco ZONTA, Stuttgart (DE); Thomas HANDTE, Filderstadt (DE); Ken TANAKA, Tokyo (DE)

(73) Assignee: Sony Group Corporation, Tokyo (JP)

(21) Appl. No.: 19/479,409

(22) PCT Filed: May 6, 2024
(86) PCT No.: PCT/EP2024/062455

§ 371 Date: Oct. 28, 2025

(30) Foreign Application Priority Data
May 12, 2023 (EP) 23173130.8

(51) Int. Cl. H04B 7/06; H04B 7/024; H04B 7/0452; H04L 5/00; H04W 28/06

(52) U.S. Cl. CPC H04B 7/0634; H04B 7/024; H04B 7/0452; H04B 7/0617; H04B 7/0626; H04B 7/0639; H04B 7/0663; H04L 5/0048; H04W 28/06

(57) ABSTRACT

A first communication device configured to communicate with one or more third communication devices in its basic service set comprises circuitry configured to transmit fourth feedback request information to the fourth communication device, the fourth feedback request information relating to feedback to be fed back by the fourth communication device and including a requested feedback format and a requested number or number range of feedback vectors; transmit fourth training data to at least the fourth communication device; receive fourth beamforming feedback from the fourth communication device, the fourth beamforming feedback including a number of feedback vectors according to the requested feedback format; determine, based on the received fourth beamforming feedback, a steering matrix for communicating with the one or more third communication devices using beamforming; and communicate with the one or more third communication devices using the determined steering matrix.

### BACKGROUND

### Field of the Disclosure

The present disclosure relates to communication devices and methods for communicating in a coordinated beamforming scenario.

### Description of Related Art

To perform beamforming, channel state information should be available at the transmitter. Feeding back the full channel coefficients in uncompressed form for each of the subcarriers can be prohibitively large. The compressed feedback schemes employed in IEEE 802.11 currently require the receiving station (STA) to compute the strongest singular vectors of the downlink channels, compress and send these back to the access point (AP). When beamforming is used for interference mitigation, as in the case of coordinated beamforming, feeding back the strongest singular vectors, corresponding to the number of spatial streams to be used, is not a good option. Such an approach is constraining the AP, which performs interference aware beamforming, to protect spatial directions which are not meaningful for the receiving stations. Furthermore, it may not provide enough information for the AP to mitigate the interference to the STA that is involved in a concurrent data exchange within the coordinated beamforming scenario.

The “background” description provided herein is for the purpose of generally presenting the context of the disclosure. Work of the presently named inventor(s), to the extent it is described in this background section, as well as aspects of the description which may not otherwise qualify as prior art at the time of filing, are neither expressly nor impliedly admitted as prior art against the present disclosure.

### SUMMARY

It is an object to modify the known concept of feedback in a coordinated beamforming scenario such that it is more appropriate for interference aware beamforming schemes. It is a further object to provide corresponding communication devices and methods as well as a corresponding computer program and a non-transitory computer-readable recording medium that stores therein a computer program product for implementing said methods.

According to an aspect there is provided a first communication device configured to communicate with one or more third communication devices in its basic service set, the first communication device comprising circuitry configured to
transmit fourth feedback request information to the fourth communication device, the fourth feedback request information relating to feedback to be fed back by the fourth communication device and including a requested feedback format and a requested number or number range of feedback vectors;
transmit fourth training data to at least the fourth communication device;
receive fourth beamforming feedback from the fourth communication device, the fourth beamforming feedback including a number of feedback vectors according to the requested feedback format;
determine, based on the received fourth beamforming feedback, a steering matrix for communicating with the one or more third communication devices using beamforming; and
communicate with the one or more third communication devices using the determined steering matrix.

According to a further aspect there is provided a fourth communication device configured to communicate with a second communication device in its basic service set, the fourth communication device comprising circuitry configured to
receive fourth feedback request information from a first communication device that is configured to communicate with one or more third communication devices in an another basic service set, the fourth feedback information relating to feedback to be fed back by the fourth communication device to the first communication device and including a requested feedback format and a requested number or number range of feedback vectors;
receive fourth training data from the first communication device;
estimate channel information based on the received fourth training data;
determine, based on the estimated channel information, feedback vectors corresponding to singular vectors of a channel between the first communication device and the fourth communication; and
transmit fourth beamforming feedback to the first communication device according to the requested feedback format, the fourth beamforming feedback including the determined feedback vectors.

According to still further aspects corresponding methods, a computer program comprising program means for causing a computer to carry out the steps of the methods disclosed herein, when said computer program is carried out on a computer, as well as a non-transitory computer-readable recording medium that stores therein a computer program product, which, when executed by a processor, causes the methods disclosed herein to be performed are provided.

Embodiments are defined in the dependent claims. It shall be understood that the disclosed methods, the disclosed computer program and the disclosed computer-readable recording medium have similar and/or identical further embodiments as the claimed devices and as defined in the dependent claims and/or disclosed herein.

One of the aspects of the disclosure is that an AP (the first communication device) informs an oSTA (overlapping STA; the fourth communication device) of an overlapping basic service set (OBSS) through a feedback request (the fourth feedback request information) that it wishes to receive beamforming feedback from it and with which parameters. This requested feedback information includes information regarding the number (or number range) of feedback vectors to be protected from interference by a transmission from the oAP (overlapping AP; the second communication device) to the oSTA during a transmission of the AP to one or more STAs (third communication devices) in its own BSS in a coordinated beamforming scenario. The feedback vectors fed back as beamforming feedback (the fourth beamforming feedback) by the oSTA to the AP are then used by the AP to construct a beamforming matrix (steering matrix) for performing the communication of the AP with the STA. This ensures that the channel or part of the channel used for the communication between oAP and oSTA is protected from the interference caused by the AP during the communication with the STA in its BSS. Further, the feedback provided by the oSTA is more appropriate and more efficient than the feedback provided according to known concepts to reach this aim.

The foregoing paragraphs have been provided by way of general introduction and are not intended to limit the scope of the following claims. The described embodiments, together with further advantages, will be best understood by reference to the following detailed description taken in conjunction with the accompanying drawings.

### BRIEF DESCRIPTION OF THE DRAWING

A more complete appreciation of the disclosure and many of the attendant advantages thereof will be readily obtained as the same becomes better understood by reference to the following detailed description when considered in connection with the accompanying drawings, wherein:

FIG. 1 shows a diagram of a coordinated beamforming scenario.

FIG. 2 shows a more detailed diagram of a coordinated beamforming scenario.

FIG. 3 shows another detailed diagram of a coordinated beamforming scenario.

FIG. 4 shows a diagram of a first embodiment of a communication scheme according to the present disclosure.

FIG. 5 shows a diagram of a second embodiment of a communication scheme according to the present disclosure.

FIG. 6 shows a diagram of a third embodiment of a communication scheme according to the present disclosure.

FIG. 7 shows a diagram of a fourth embodiment of a communication scheme according to the present disclosure.

FIG. 8 shows a flow chart of an embodiment of a communication method of an access point according to the present disclosure.

FIG. 9A shows a flow chart of a first embodiment of a method for constructing the steering matrix according to the present disclosure.

FIG. 9B shows a flow chart of a second embodiment of a method for constructing the steering matrix according to the present disclosure.

FIG. 10 shows a flow chart of an embodiment of a communication method of a station according to the present disclosure.

FIG. 11 shows a schematic diagram of an embodiment of a communication system according to the present disclosure.

FIG. 12 shows a flow chart of another embodiment of a communication method of an access point according to the present disclosure.

FIG. 13 shows a flow chart of another embodiment of a communication method of a station according to the present disclosure.

### DETAILED DESCRIPTION OF THE EMBODIMENTS

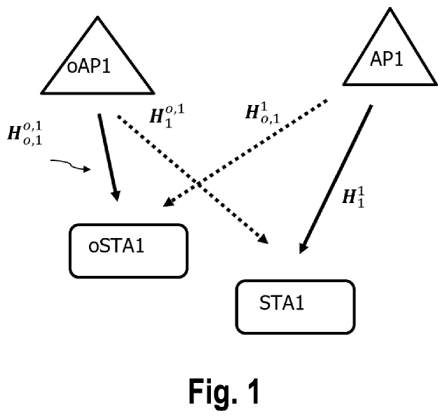

Referring now to the drawings, wherein like reference numerals designate identical or corresponding parts throughout the several views, FIG. 1 shows a diagram of a coordinated beamforming (CBF) scenario. Two APs, AP1 (herein also called “first communication device”) and oAP1 (herein also called “second communication device”), with multiple antennas, each communicating with one STA, STA1 (herein also called “third communication device”) and oSTA1 (herein also called “fourth communication device”), respectively. The communication between AP1 and STA1 and between oAP1 and oSTA1 is fully or partially overlapping in time. The communication between AP1 and STA1 occurs over the channel denoted with

$${H}_{1}^{1}$$

and causes interference to oSTA1 on the channel

$${H}_{o , 1}^{1} .$$

Similarly, the communication between oAP1 and oSTA1 occurs over the channel

$${H}_{o , 1}^{o , 1}$$

and causes interference for STA1 on the channel

$${H}_{1}^{o , 1} .$$

AP1 and oSTA1 do not exchange data (i.e. do not perform communication with each other), but may exchange control messages. The same holds for oAP1 and STA1.

It shall be noted that the following notation conventions are used herein: Superscripts (o,1) and (1) indicate a value requested or transmitted by oAP1 and AP1, respectively. Subscripts (o,1) and (1) indicate a value that was received or requested by oSTA1 and STA1, respectively. When it is clear from the context, subscripts and superscripts are omitted. N_{req} denotes the number of feedback vectors that an AP requests from the STA, which should be protected from interference (e.g. AP1 requests from oSTA1). No denotes the number of feedback vectors that an AP requests from the STA towards which it will send the data communication (e.g., AP1 requests from STA1).

The APs apply beamforming (BF) to enhance the communication link towards their own STAs and protect the communication link towards the STA from the other BSS. For example, the signal transmitted from oAP1 has the form

$${x}_{t} = {Q}_{}^{( o , 1 )} {s}_{o , 1}^{o , 1} .$$

The applied beamforming matrix

$${Q}_{}^{( o , 1 )} has {N}_{C}^{( o , 1 )}$$

columns and

$${N}_{r}^{( o , 1 )}$$

rows, where

$${N}_{C}^{( o , 1 )}$$

corresponds to the number of spatial streams of oSTA1 and

$${N}_{r}^{( o , 1 )}$$

corresponds to the number of transmit antennas or the number of spatial streams sent during the transmission of a training data unit (NDP) (herein also called “training data”). The beamforming matrix

$${Q}_{}^{( o , 1 )}$$

depends not only on the channel

$${H}_{o , 1}^{( o , 1 )}$$

but also the interfering channel

$${H}_{1}^{( o , 1 )} .$$

To make the latter channel information available at the oAP1, the sounding needs to be adapted. A particularity of CBF is that i) the sounding procedure needs to follow the multiuser case even when oAP1 has only one STA to serve and ii) in that case the number of columns of the beamforming matrix

$${Q}_{}^{( o , 1 )}$$

only depends on the number of spatial streams of the STAs within the respective BSS (oSTA1 in this example) and not on the number of all the STAs sounded (STA1).

The feedback scheme currently covered by the standard IEEE 802.11, even though left for implementation, is widely considered to follow the logic below, depicted for the particular case of

$${H}_{o , 1}^{o , 1} :$$

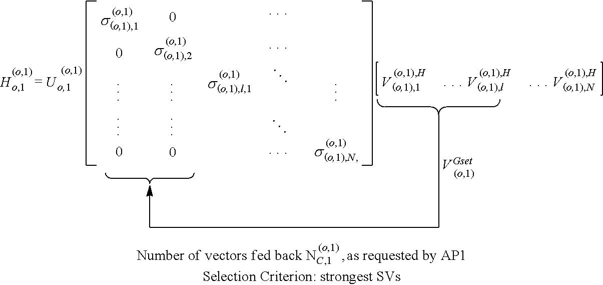

More precisely, the oSTA1 creates a singular value decomposition (SVD) of the

$${H}_{o , 1}^{o , 1}$$

channel, selects a set of V vectors depicted as

$${V}_{( o , 1 )}^{Gset}$$

consisting of

$${N}_{SS , o , 1}^{( o , 1 )}$$

vectors corresponding to the strongest singular values, denoted as

$${σ}_{( o , 1 ) , 1}^{o , 1} ... {σ}_{( o , 1 ) , {N}_{SS}}^{( o 1 )} .$$

These vectors are further compressed by performing a series of matrix rotations and are sent back to the AP.

Straightforwardly extending this feedback scheme to the interference channels would imply that STA1 would need to compute the feedback vectors towards the oAP1 by choosing the singular vectors of the channel matrix, corresponding to the number of streams to be used in the data exchange, i.e. N_{SS,1}.

Sending the strongest singular vectors, corresponding to the number of streams used in the data communication, has various drawbacks if applied for the channels between AP1 and oSTA1 and between oAP1 and STA1, respectively. Firstly, oAP1 and AP1 do not exchange data with STA1 and oSTA1 respectively, therefore these APs do not need to ensure a good quality communication link towards STA1 and oSTA1, respectively, thus the strongest singular vectors of the beamforming channels

$${H}_{1}^{o , 1} and {H}_{o , 1}^{1}$$

will not be effectively used. Furthermore, protecting the singular vectors of these channels can unnecessarily constrain the precoder design of the communication links on

$${H}_{o , 1}^{o , 1} and {H}_{1}^{1} .$$

Finally, if the fed back information is limited by a number of streams, which is different than a channel rank, then it is also impossible for the AP to reconstruct a null space of the interfered channel.

For the reasons mentioned above, the selection matrix V^{SEL} of vectors to be fed back by the STA, which needs interference protection, should be adapted in case of the interference channels for coordinated beamforming as follows (N_{I} denotes the number of vectors that are fed back):

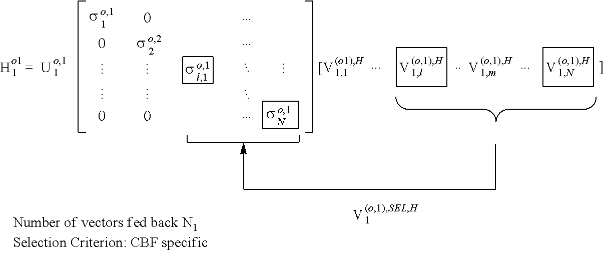

Number of vectors fed back N_{I}
Selection Criterion: CBF specific

Hereinafter, different embodiments will be described how to select the vectors within the matrix

$${V}_{1}^{( o , 1 ) , SEL}$$

and the implications on the required feedback from the interference protected STA (i.e., STA1 in case of oAP1), on the processing steps at the oAP1 and on the sounding flow. Corresponding changes to accommodate the enhanced selection methods are described. The properties of the interference channel have an impact on the direct communication channel as well, and the feedback from STA1 to AP1 should be adapted accordingly. Finally, required signaling adaptions are discussed. The case of oAP1 to STA1 is chosen as example only to make the description clearer.

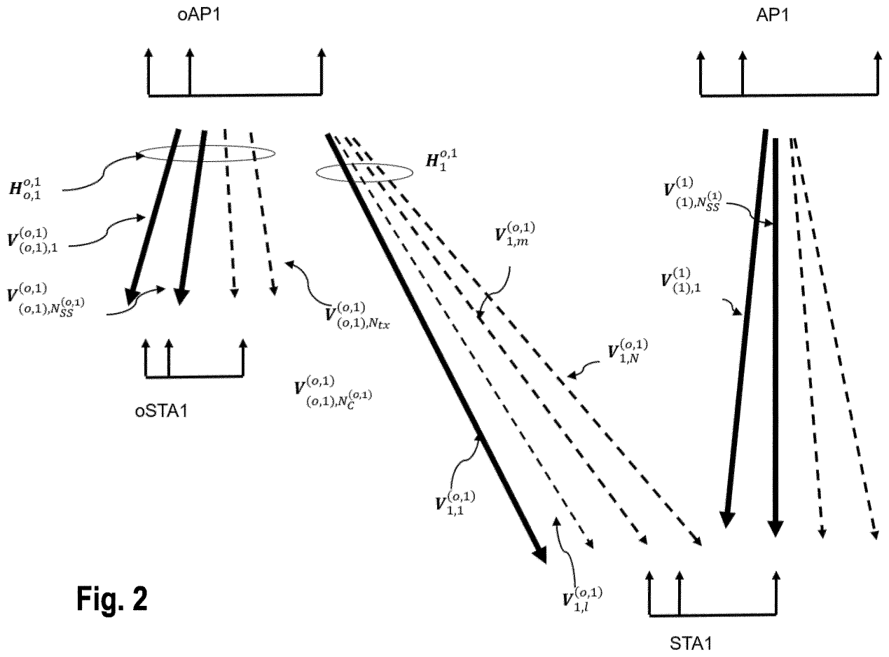

FIG. 2 shows a more detailed diagram of a coordinated beamforming scenario illustrating a subspace-based description of the selection criterion for feedback of interference and communication channels. In this figure, the channel

$${H}_{1}^{( o , 1 )}$$

is represented only by the right singular vector directions

$$\begin{matrix}{V}_{1 , 1}^{( o , 1 )} & … & {V}_{1 , N}^{( o , 1 )} .\end{matrix}$$

The same holds for the channels

$${H}_{o , 1}^{( o , 1 )} and {H}_{1}^{1} .$$

The arrows shown in continuous lines depict channel directions corresponding to strong singular values, whereas the dashed lines correspond to weaker singular values (potentially null or below an interference threshold). For the communication link the strong right singular vectors are of interest as these are ensuring the best SINR (signal-to-interference-plus-noise-ratio) levels. For the interfering link, the directions that are more of interest are the ones corresponding rather to weaker singular vectors (preferably null or below an interference threshold).

To select the N_{I} vectors in the

$${V}_{1}^{( o , 1 ) , SEL} ,$$

a first option is that STA1 first chooses the singular vectors corresponding to the weakest singular values, which are below a threshold, corresponding to an interference tolerance. The interference tolerance can be chosen based on the MCSs (modulation coding schemes) supported and can be indicated by the APs. Nₙ denotes the number of the vectors selected in this manner. Depending on the configuration, Nₙ can be relatively large, in some cases even larger than the dimension of the actual channel. For example, if the configuration is eight antennas at the AP and two at STA1, then the null space dimension is at most six, whereas the channel dimension at most two. For this reason selecting a reduced dimension space to be fed back is of interest. For other configurations, e.g. the same number of antennas at both AP and STA, Nₙ may be 0, in which case interference protection may be difficult or impossible.

Conventionally, the number of vectors to be fed back is selected by the AP, which requires the feedback, and is related to the number of spatial streams that may be used in the communication between the respective AP and STA. In case of CBF, several further conditions come into play.

In case of the interfering link, the AP (oAP1) requires from STA1 a number of feedback vectors, denoted as

$${N}_{req}^{( o , 1 )}$$

and for which the following should hold:

i) It should be larger than or equal to the largest number of interference directions that it can protect, further denoted by

$${N}_{iofs}^{( o , 1 )} ,$$

as indicated in operation conditions, and smaller than or equal to the largest null space dimension, further denoted as

$${N}_{ns}^{( o , 1 )} ,$$

that it can apply as indicated in the capabilities.

ii)

$${N}_{req}^{( o , 1 )}$$

should be larger than or equal to the number of spatial streams

$${N}_{SS , o , 1}^{( o , 1 )}$$

that could be used during the communication between oAP1 and oSTA1, to ensure sufficient degrees of freedom for the precoder design of oAP1.

$${N}_{SS , o , 1}^{o , 1}$$

may not be known before the training. Thus, a value corresponding to the maximum number of spatial streams as limited, e.g. by operation mode, capabilities or modulation, may be used instead. This number can further correspond to the

$${N}_{C ,}^{( o , 1 )}$$

value that oSTA1 is requested by the oAP1 to feedback, e.g. in an NDP (null data packet) announcement.

An alternative is that the AP only signals the upper and lower bounds of an interval in which the number of fed back vectors should lie, e.g.

$${N}_{req , min}^{( o , 1 )} = max ( {N}_{SS , o , 1}^{( o , 1 )} , {N}_{iof}^{( o , 1 )} ) and {N}_{req , max}^{( o , 1 )} = {N}_{ns}^{( o , 1 )} .$$

On the other hand, in order to be fully protected from interference, STA1 should determine a number of directions on which the interference level should be controlled by oAP1. This number is further referred to as Nᵢₙₜ.

Further, Nᵢₙₜ should correspond to the number of spatial streams that STA1 will receive from AP1. Similar to the discussion at item ii) above, however, only an upper limit of this value can be known. This upper limit can be

$${N}_{c , 1}^{1}$$

as requested by the AP1 (e.g. in the NDP announcement, if the announcement has already been sent) or by internally determining an estimate based on operation mode, capabilities, and/or modulation.

The implications on feedback towards oAP1 are as follows. The feedback dimensions from STA1 towards oAP1 and AP1 depend on N_{n,1} (the number of singular vectors of the channel matrix between oAP1 and STA1, corresponding to singular values equaling null or smaller than a threshold),

$${N}_{req}^{( o , 1 )} and {N}_{int , 1} :$$

a)

$$If {N}_{req}^{( o , 1 )} \geq {N}_{int , 1}$$

and smaller than or equal to Nₙ, it is the ideal case and the number of selected vectors to be fed back by STA1, N_{I,1}, is equal to

$${N}_{req}^{( o , 1 )} .$$

b) If

$${N}_{req}^{( o , 1 )} > {N}_{n , 1} ,$$

the selection consists of N_{n,1} singular vectors corresponding to the directions below the interference threshold, an indication of N_{n,1} and possibly a padding until the required size. An indication that it may not be possible to respect the interference conditions as desired may be sent to both the oAP1 and AP1. Alternatively, weakest

$${N}_{req}^{( o , 1 )}$$

singular vectors can be fed back; however, in this case the corresponding SNR values should be present.

c) If

$${N}_{req , max}^{( o , 1 )} or {N}_{req}^{( o , 1 )}$$

are strictly smaller than N_{n,1}, a reduction of the null space may be performed, and there are several ways in which this can be performed. Some examples include:
c1) Communication channel-independent methods, such as arranging the singular vectors in decreasing order and choosing the last

$${N}_{req}^{( o , 1 )}$$

values; or
c2) Correlation based methods: the STA chooses the singular vectors which are also highest correlated to the best channel directions. This ensures that the directions STA1 mostly needs to use in the communication with AP1 are also the ones which are mostly protected from interference.

The implications on the feedback towards AP1 are as follows:

a) If N_{n,1<1}, then interference mitigation may not be possible and an indication as such should be sent.

b) If

$${N}_{req}^{( o , 1 )} \leq {N}_{int , 1} or {N}_{req , min}^{( o , 1 )} \leq {N}_{int , 1} or ii ) {N}_{int , 1} \geq {N}_{n , 1}$$

but strictly larger than 1, interference protection may be possible but on a smaller number of streams than desired. In this case, the feedback from STA1 to AP1 should indicate that an operation using desired number of spatial streams may not be achieved.

The operation and related feedback in this case further depend on the coordination type. For example, if oAP1 has obtained the channel access or has a scheduled service period and allows AP1 on opportunistic basis, then AP1 needs to enforce interference constraints but may need to reduce the number of streams it will use in the communication with STA1.

Therefore, the APs should request from the STAs within their BSS, as part of the sounding feedback, a value indicating the minimum between a maximum number of nulling directions that the channel allows and the N_{req} that the other AP (i.e., controlling the interference) has requested. This value is referred to as N_{nd}. Alternatively, the STAs may be only required to indicate if the N_{nd} value is smaller or equal than the number of spatial streams that are sounded between the AP and the STA or are planned to be used in the downlink communication between the AP and the STA within its BSS.

For sequential sounding schemes, depending on the order of the APs performing the sounding some may have more information than others. For example, if the oAP1 performs the sounding after AP1, it may already be aware of

$${N}_{nd}^{1}$$

and may adapt the requested parameters accordingly (e.g.,

$${N}_{c}^{( o , 1 )} ) .$$

Furthermore, if one of the APs takes the role of a master AP, which coordinates the CBF sounding, then these parameters may be decided during a coordination phase, where tradeoffs between the N_{req} and Nᵢₙₜ can be found.

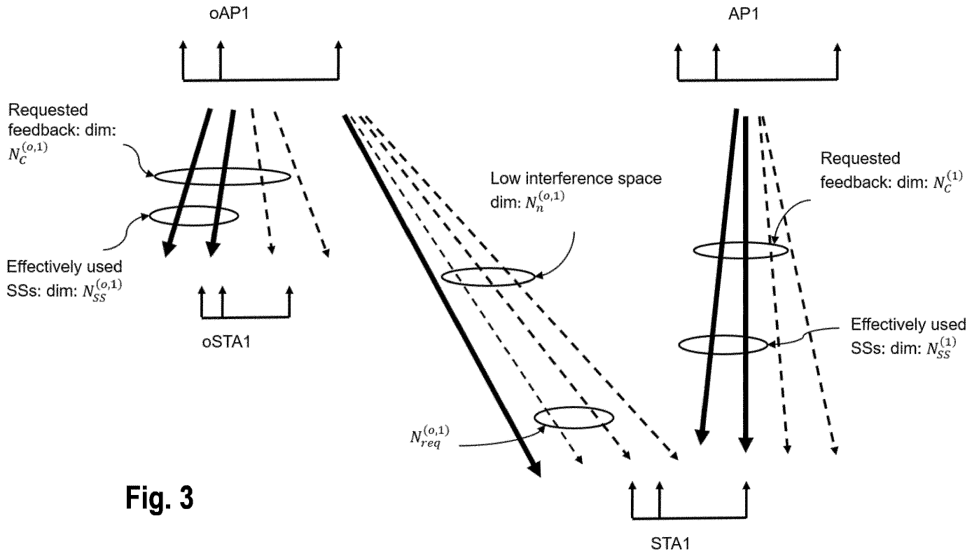

FIG. 3 shows another detailed diagram of a coordinated beamforming scenario illustrating the parameters involved and the conditions on the feedback as well as the relation between requested feedback parameters.

$${N}_{C}^{( o , 1 )} ,$$

the number of requested feedback dimensions from oAP1 to oSTA1, is larger than or equal to the number of effective spatial streams

$${N}_{SS}^{( o , 1 )}$$

that should be used within the communication between these two STAs. A similar relation exists between the number of requested feedback directions from the AP1 to the STA1

$${N}_{C}^{( 1 )} ,$$

which is larger than the effective number of streams

$${N}_{SS}^{( 1 )} .$$

The dimension of the null space of the channel

$${H}_{1}^{( o , 1 )} , {N}_{n}^{( o , 1 )} ,$$

is further depicted along with the case in which the requested feedback from the oAP1 is smaller than or equal to this value. The latter relation is however strictly exemplary, as in reality oAP1 cannot know whether this relation holds or not and further steps need to be signal this information, as discussed herein.

The interplay between the parameters

$${N}_{req}^{( o , 1 )} , {N}_{n}^{( o , 1 )} , {N}_{C}^{( 1 )} and {N}_{C}^{( o , 1 )}$$

and the required actions in case the relations are met can be summarized as follows:

$$\begin{matrix}\begin{matrix}{{N}_{req}^{( o , 1 )}}_{⟷} \\ {{N}_{n}^{( o , 1 )}}_{⟷}\end{matrix} \} & Adjust {N}_{I} = {N}_{n}^{( o , 1 )} \\ \begin{matrix}{{N}_{req}^{( o , 1 )}}_{⟷} \\ {{N}_{n}^{( o , 1 )}}_{⟷}\end{matrix} \} & \begin{matrix}Subspace selection \\ {N}_{I} = {N}_{req}^{( o , 1 )}\end{matrix} \\ \begin{matrix}{{N}_{n}^{( o , 1 )}}_{⟷} \\ {{N}_{req}^{( o , 1 )}}_{⟷} \\ {{N}_{C}^{( 1 )} ( {N}_{SS}^{( 1 )} )}_{⟷}\end{matrix} \} & \begin{matrix}Report towards AP 1 \\ {N}_{nd}^{( 1 )} = min ( {N}_{req}^{( o , 1 )} , {N}_{n}^{( o , 1 )} )\end{matrix}\end{matrix} \} @ STA 1$$

$$@ oAP 1 \{ \begin{matrix}Correlation based on design in interference space & \{ \begin{matrix}{{N}_{req}^{( o , 1 )}}_{⟷} \\ {{N}_{C}^{( o , 1 )} ( {N}_{SS}^{( o , 1 )} )}_{⟷}\end{matrix} \\ Coordination case & \{ \begin{matrix}{{N}_{req}^{( o , 1 )}}_{⟷} \\ {{N}_{C}^{( 1 )} ( {N}_{SS}^{( 1 )} )}_{⟷}\end{matrix}\end{matrix}$$

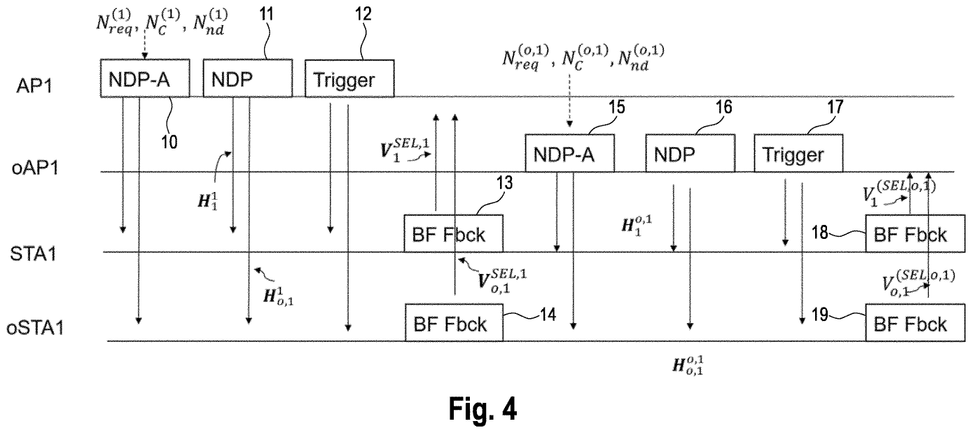

FIG. 4 shows a diagram of a first embodiment of a communication scheme according to the present disclosure. According to this embodiment, the sounding flow as shown in FIG. 4 can be used for cases, in which N_{req}=Nₙ or the null space reduction is performed based on communication channel-independent methods. The new values N_{req} (defining a “requested number of feedback vectors”) or the limits (N_{req,min}, N_{req,max}) (defining a “requested number range of feedback vectors”) are signaled, e.g. within the NDP announcement frames 10, 15, which are starting the sounding procedures.

$${N}_{c}^{( o , 1 )}$$

(the number of feedback vectors that the oAP1 requests from oSTA1) should be chosen such that all singular vectors corresponding to the kernel of the matrix

$${H}_{o , 1}^{( o , 1 )}$$

can be retrieved at the oAP1. This may be relevant in the case the partial channel information in

$${V}_{o , 1}^{SEL , o , 1}$$

is used on top of the reconstruction of the

$${V}_{1}^{SEL , o , 1}$$

to obtain the final steering matrices.

After the NDP announcement 10, a training data unit (NDP) 11 is sent to STA1 and oSTA1, such that they estimate the channels from AP1,

$${H}_{1}^{1} and {H}_{o , 1}^{1} ,$$

respectively. The number of training units within the NDP 11 may be chosen such that all the transmit antennas at the AP1 are sounded, however it should not exceed the maximum number of training fields that can be processed by any of the two STAs (STA1 and oSTA1), as indicated within their capabilities fields. Therefore, AP1 needs to be aware of the capabilities of the oSTA1, which is not within its BSS. Alternatively, AP1 may send the NDPs with the number of training fields corresponding to the maximum number of training fields that can be processed by STA1 and refuse to involve within a coordinated beamforming scenarios, an oSTA which cannot process the required number of training fields during the respective sounding stage. To collect the feedback, one option is to use trigger frames 12, 17 as shown in FIG. 4 or polling frames (not shown). The trigger frames 12, 17 are triggering STA1 and oSTA1 to send the feedback (BF Fbck) 13 (“third beamforming feedback”), 14 (“fourth beamforming feedback”) and 18 (“further third beamforming feedback”), 19 (“further fourth beamforming feedback”) in the format indicated within the NDP announcement 10, 15.

Generally, the feedback vectors correspond to one or more singular vectors of the channel matrix between AP1 and oSTA1 and between oAP1 and STA1, respectively. The number of feedback vectors in the BF feedback is generally smaller than or equal to the requested number or the maximum number of the requested number range.

For the sequential scheme shown in FIG. 4, the sounding at the oAP1 will be performed after the sounding of the AP and consists of similar steps. Hence, after the NDP announcement 15, an NDP 16 is sent to STA1 and oSTA1 as well such that they estimate the channels from oAP1,

$${H}_{1}^{o , 1} and {H}_{o , 1}^{o , 1} ,$$

respectively.

For the first AP, which performs the sounding, (e.g., AP1 in FIG. 4), N_{nd} values are not available at the time of the feedback collection stage. This value can be requested after the sounding, e.g., when a transmit opportunity (TXOP) for communication between the AP1 and STA1 is obtained. Generally, N_{nd} for STA1 can be set as: i) the number of directions of the channel between oAP1 and STA1 corresponding to a power below a threshold or ii) the number of feedback vectors the oAP1 requests from STA1 or iii) the minimum between i) and ii).

For the cases in which N_{req}<Nₙ, if the correlation criterion is used for the dimension reduction, the sounding flow should be adapted such that the respective STA can obtain both channel estimates (e.g., in the case of STA1

$${H}_{1}^{1} and {H}_{1}^{o , 1} .$$

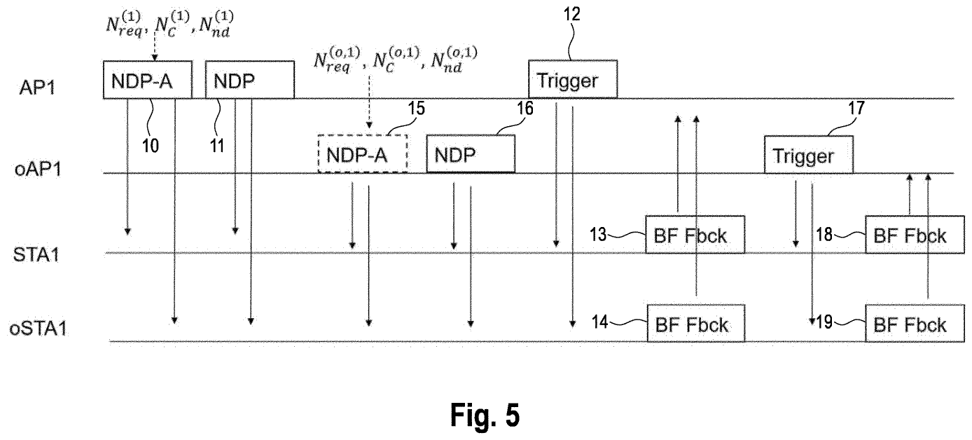

If a sounding flow such as the one in FIG. 4 is used, then only the STA1 has enough information to send a feedback based on the reduced null space to the oAP1. For the oSTA1 to be able to also perform the reduction, an additional feedback round is required from AP1 to oSTA1, which increases the overhead. FIG. 5 shows a diagram of a second embodiment of a communication scheme according to the present disclosure, according to which an adapted sounding flow for reduced null space is used.

According to the sounding scheme shown in FIG. 5, first the training units 11, 16 are sent such that all STAs involved can estimate the channels from both APs. The feedback round subsequently follows and consists of the two APs AP1, oAP1 requesting feedback from the STAs STA1, oSTA1 involved in the training. After each feedback request (either included in the NDP-A frames 10, 15, or implied by the transmission of the training units 11, 16), the addressed STAs send the feedback (BF Fbck) 13, 14 and 18, 19 in the format indicated within the NDP-A frames 10, 15.

If one of the APs assumes the role of a master AP, then all sounding setup information can be sent within one NDP-A frame (e.g. NDP-A frame 10) from the master AP (e.g. AP1). In this case, the second NDP-A block 15 (depicted in dashed line) may be omitted.

In some particular cases, e.g., in which STA1 and oSTA1 use only one stream in the communication with AP1 and oAP1, respectively, it can be shown that only applying the fed back vector V, corresponding to one of the null directions, from oSTA1 and STA1, respectively, as steering vector by AP1 and oAP1 has a sufficient performance. In this case, the feedback from STA1 towards AP1 and from oSTA1 towards oAP1 can be omitted or reduced, which further reduces the overhead. As reduced feedback, oSTA1 may be required to transmit an SNR value, to ensure that it is in a high SNR regime, in which case the steering matrix, obtained solely from the null direction (singular vector corresponding to a null or smaller than a threshold singular value) fed back by STA1, performs reasonably good.

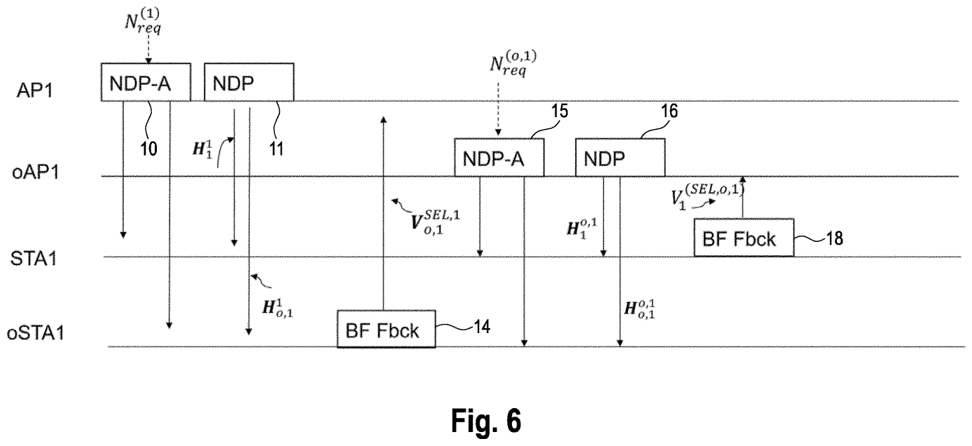

The sounding phase may also be completely separated for the oSTAs. An advantage can be that in this case the oSTAs do not need to be capable of processing trigger frames. FIG. 6 shows a diagram of a third embodiment of a communication scheme according to the present disclosure, according to which simple non-trigger based (non-TB) feedback is performed. In the scheme depicted in FIG. 6, oSTA1 and STA1 are requested to provide their beamforming feedback information within a predefined interval (e.g., SIFS (short interframe space interval)) from the end of the NDP frame. The scheme shown in FIG. 6 is also the one which can be used when implementing a steering matrix only based on the null direction feedback.

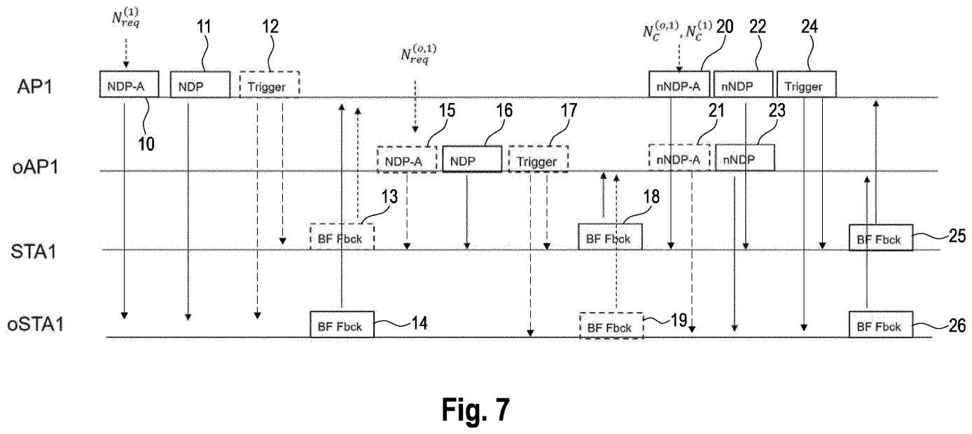

The communication schemes shown in FIGS. 4-6 imply that the communication directions are computed in the null space of the interference channel based on only partial information about the direct communication channel (V matrices and SNR values). Examples on how this may be performed will be explained below. This may not be sufficiently accurate, particularly in cases when SNR is low. FIG. 7 shows a diagram of a fourth embodiment of a communication scheme according to the present disclosure, according to which an enhanced sounding flow that overcomes this issue as well as a drawback regarding the incomplete CSI information in case of sequential sounding is applied.

An essential part of this operation is the sending of nNDP (null NDP frames; herein also called “modified third feedback information” and “modified fourth feedback information”) 20, 21, which are frames sent with steering matrices computed based on the fed back V^{(SEL)} matrices from oSTA1 and STA1, respectively. The number of training fields within the subsequent nNDP data units (herein also called “modified third training data” and “modified fourth training data”) 22, 23 is smaller or equal than Nₙₛ, which can be smaller than the number of transmit antennas. Thus, the number of rows of the feedback as indicated within the nNDP-A frames 20, 21 should also be smaller or equal than Nₙₛ and therefore smaller than it would be in the case of a regular sounding (e.g. as shown in FIGS. 4 and 5). Furthermore, since the interference protection is already applied, the two nNDPs 22, 23 can be transmitted simultaneously by both APs. However, in this case the lengths of the two nNDPs 22, 23 should be the same, meaning that the number of training fields (e.g. ELTFs; enhanced long training fields such as HE, EHT LTFs) should be smaller than or equal to the minimum between Nₙₛ¹ and Nₙₛ^{(0,1)}. These two values can be exchanged between the APs prior to the sounding phase and are not subject to frequent changes. The number of columns of the feedback (BF Fbck; herein also called “modified third beamforming feedback” and “modified fourth beamforming feedback”) 25, 26 from STA1 and oSTA1 towards AP1 and oAP1, respectively, can be requested within the NDP-A frames 10, 15 initiating the CBF sounding (instead of the nNDP-A frames 20, 21), in which case the nNDP-A frame(s) 20 (and 21) is (are) only a trigger to start and align the NDP transmission.

The blocks shown in dashed lines are optionally present in the scheme. For example, the nNDP-A 21 may be omitted in case one of the APs assumes the role of a master AP or coordinator of the CBF scheme. Another case in which it can be omitted is by allowing the AP which gains access to the medium to start this modified training stage. This is particularly relevant when the initial NDP-A frames 10, 15 contain the required feedback request information. For the scheme depicted in FIG. 7, the STAs are not required to send N_{nd} information to their respective APs with which these are associated.

Furthermore, the number of columns of the requested feedback matrices may be reduced to the number of spatial streams, as recommended by the non-AP STAs STA1, oSTA1. This is because the AP does not need to perform additional operations within the feedback space in this case.

It shall be noted that the blocks shown in dashed lines can be omitted depending on the respective implementation. For example, the feedback 14 from oSTA1 to AP1 and the feedback 19 from STA1 to oAP1 may be necessary in the first two phases, but the feedback from the respective own STAs (i.e. in the BSS of the respective AP) is optional. A benefit of omitting this additional feedback is the possibility to perform the sounding scheme without trigger frames 12, 17, which further reduces the training time.

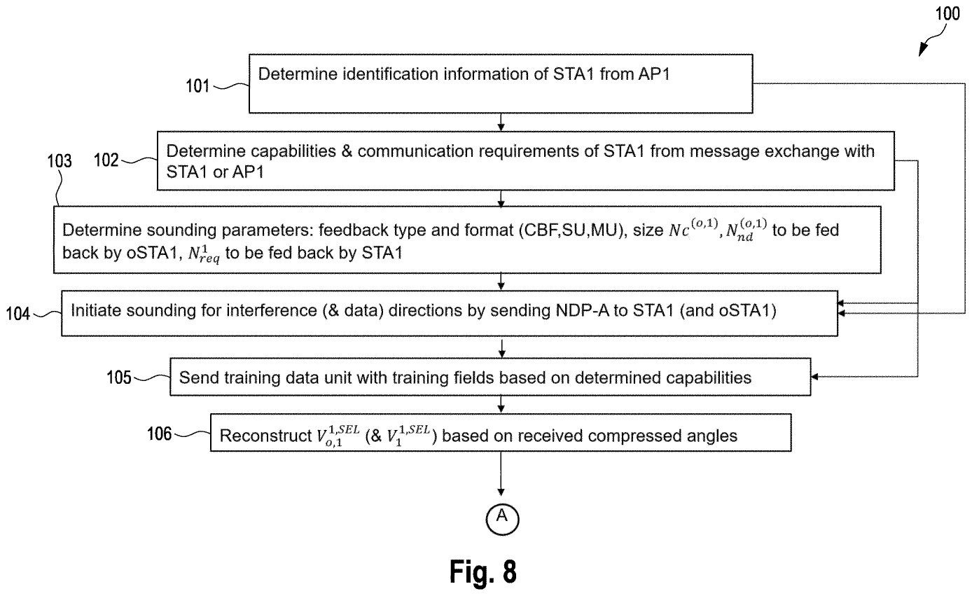

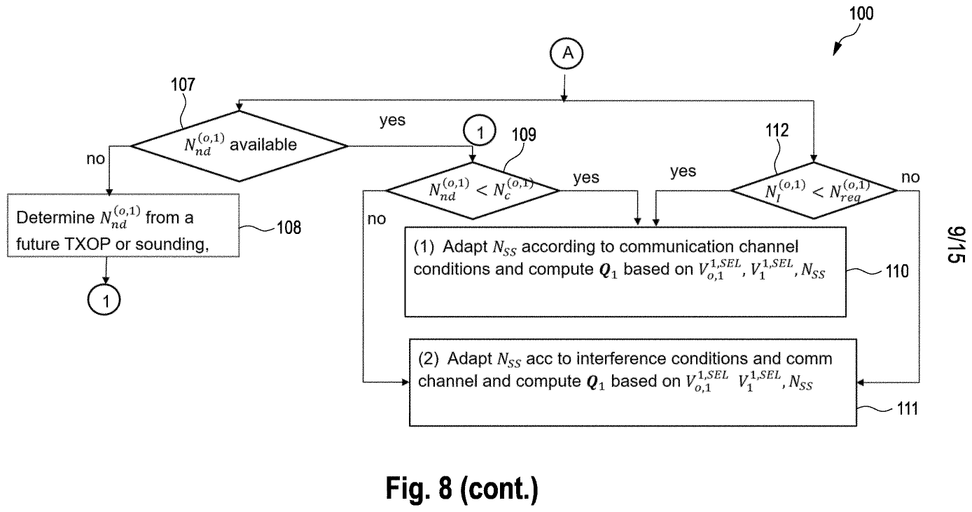

FIG. 8 shows a flow chart of an embodiment of a communication method 100 of an AP (AP1 and oAP1) according to the present disclosure. As an example, the steps of the communication method are shown for the oAP1, but the same steps are generally performed by the AP1.

Prior to starting the sounding procedure, each of the APs that are performing CBF should have information about both the STAs in their own BSS as well as the STAs in the oBSS, which should be protected from the interference. For example, oAP1 should have the following information about STA1:
identification information for addressing STA1;
maximum number of spatial streams that can be processed by STA1, which will be used in determining N_{req};
bandwidth that can be used by STA1 and within which or part of which the sounding should be performed;
whether puncturing is allowed, determining if in case part of the channel cannot be used within transmission, STA1 can still participate in the CBF and sounding;
if compressed LTFs (long training fields) can be used by STA1, which may be decisive in choosing the format of the training units used within the sounding;
maximum number of spatial streams which can be received within the sounding, referred to as Beamformee STS and based on which the number of LTFs within the NDPs may be decided; and
maximum dimension of the feedback that can be provided by the STA to an AP with which it does not perform data exchange (or within a coordinated beamforming scenario).

This information is required by an AP in addition to the information that it has about its own STAs, particularly with respect to the number of spatial streams, bandwidth, and punctured channels. The identification information and operating bandwidth may be exchanged by the two APs, the rest of the information can be obtained by oAP1 either from AP1 or directly from STA1. When sending the NDP, the maximum number of long training fields (LTFs) should not exceed the maximum number of Beamformee STSs signaled by both STAs and oSTAs.

In a first step 101, identification information of STA1 is determined. This can be obtained either from AP1 via an information exchange, e.g. a coordinated beamforming setup, or can be advertised by the STA1. In a second step 102, capabilities and communication requirements of STA1 are determined from a message exchange with STA1 or AP1. In a third step 103, sounding parameters are determined, including feedback type and format (CBF, SU, MU), size

$$N {c}_{}^{( o , 1 )} , {N}_{nd}^{( o , 1 )}$$

to be fed back by oSTA1, and

$${N}_{req}^{1}$$

to be fed back by STA1. CBF format refers to the format that would be required in coordinated beamforming schemes and should indicate, e.g., if the feedback vectors from the STA1 correspond to the null space directions or the kernel of the channel matrix between oAP1 and STA1, the number of the feedback vectors from STA1, if compression of the feedback vectors shall be used, which compression parameters can be used (e.g., number of Givens angles, values of the diagonal exponential values used in preparing the matrix for each Givens rotation, whether SNR values, averaged over the subcarriers) should be included as part of the feedback from STA1. In a fourth step 104, sounding for interference (and optionally data) directions is initiated by sending NDP-A to STA1 (and optionally oSTA1). In a fifth step 105, a training data unit with training fields is transmitted based on determined capabilities. In a sixth step 106,

$${V}_{o , 1}^{1 , SEL} ( \& { V}_{1}^{1 , SEL} )$$

is reconstructed based on received compressed angles.

Subsequently, different cases are distinguished. In a first case, it is checked in step 107 if

$${N}_{nd}^{( o , 1 )}$$

is available. If not, in step 108 it

$${N}_{nd}^{( o , 1 )}$$

is determined from a future TXOP or sounding. Subsequently, it is continued with step 109, which is also carried out if it is found in step 107 that

$${N}_{nd}^{( o , 1 )}$$

is available.

In step 109, it is checked if

$${N}_{nd}^{( o , 1 )} < {N}_{c}^{( o , 1 )} .$$

If yes, in step 110, N_{SS} is adapted according to communication channel conditions and Q₁ is computed based on

$${V}_{o , 1}^{1 , SEL} , {V}_{1}^{1 , SEL} ,$$

N_{SS}. If no, in step 111, N_{SS} is adapted according to interference conditions and the communication channel and Q₁ is computed based on

$${V}_{o , 1}^{1 , SEL} {V}_{1}^{1 , SEL} ,$$

N_{SS}. Adapting to the communication channel shall be understood such that the number of spatial streams that will be used may be reduced according to the potential residual interference due to the fact that not all desired directions can be protected by the other AP.

In another case, it is checked in step 112 if

$${N}_{I}^{( o , 1 )} < {N}_{req}^{( o , 1 )} .$$

If yes, step 110 is carried out. If no, step 111 is carried out.

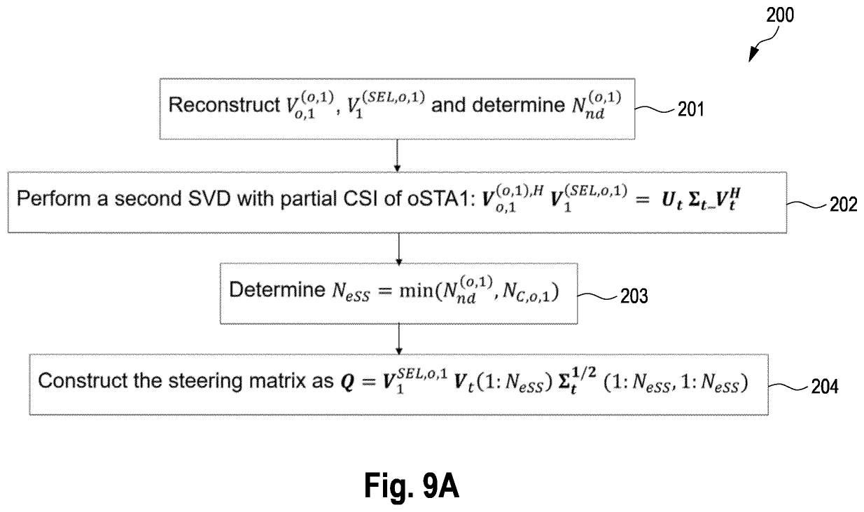

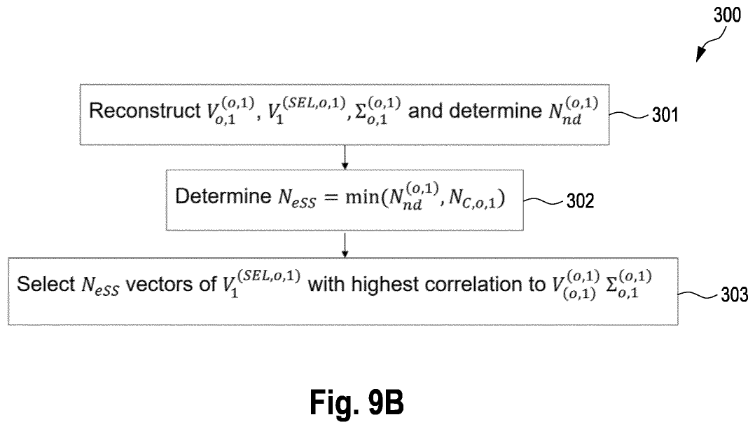

The steering matrices can be computed from the fed back vectors, e.g. as illustrated in FIGS. 9A and 9B. FIG. 9A shows a flow chart of a first embodiment of a method 200 for constructing the steering matrix according to the present disclosure based on secondary SVD. In a first step 201

$${V}_{o , 1}^{o , 1} and {V}_{1}^{( SEL , o , 1 )}$$

are reconstructed from the beamforming feedback information and

$${N}_{nd}^{( o , 1 )}$$

is determined. In a second step 202 a second SVD is performed with the partial CSI of oSTA1:

$${V}_{o , 1}^{( o , 1 ) , H} {V}_{1}^{( SEL , o , 1 )} = {U}_{t} {\sum }_{t -} {V}_{t}^{H} .$$

In a third step 203 the number of effective spatial streams to be used in the downlink communication between oAP1 and oSTA1

$${N}_{eSS} = min ( {N}_{nd}^{( o , 1 )} , {N}_{C , o , 1} )$$

is determined. In a fourth step 204 the steering matrix is constructed as

$$Q = {V}_{1}^{SEL , o , 1} {V}_{t} ( 1 \text{:} {N}_{eSS} ) {\sum }_{t}^{\frac{1}{2}} ( 1 \text{:} {N}_{eSS} , 1 : {N}_{eSS} ) .$$

FIG. 9B shows a flow chart of a second embodiment of a method 300 for constructing the steering matrix according to the present disclosure from the null space feedback. In a first step 301

$${V}_{o , 1}^{( o , 1 )} and {V}_{1}^{( SEL , o , 1 )}$$

are reconstructed

$${N}_{nd}^{( o , 1 )}$$

is determined. In a second step 302

$${N}_{eSS} = min ( {N}_{nd}^{( o , 1 )} , {N}_{C , o , 1} )$$

is determined. In a third step 303 N_{eSS} vectors of

$${V}_{1}^{( SEL , o , 1 )}$$

with highest correlation to

$${V}_{( o , 1 )}^{( o , 1 )} {\sum }_{o , 1}^{( o , 1 )}$$

are selected.

For the cases in which the beamforming feedback is based on the kernel of the channel matrix between oAP1 and STA1, the embodiments of the methods depicted in FIGS. 9A and 9B can still be used. However, a preceding operation should be performed by the oAP1 to retrieve the null space matrix from the kernel of the channel matrix. More specifically, after reconstructing the

$${V}_{1}^{( SEL , o , 1 )}$$

matrix from the beamforming feedback operation, an orthogonal set of vectors

$${W}_{1}^{( SEL , o , 1 )} to {V}_{1}^{( SEL , o , 1 )}$$

is found. The subsequent steps (i.e., steps 202-204 in FIG. 9A and steps 302-303 in FIG. 9B) are performed with

$${W}_{1}^{( SEL , o , 1 )}$$

instead of

$${V}_{1}^{( SEL , o , 1 )} .$$

The two spaces: the kernel and the null space are complementary and methods to obtain one of the space from the other one are generally known in the art.

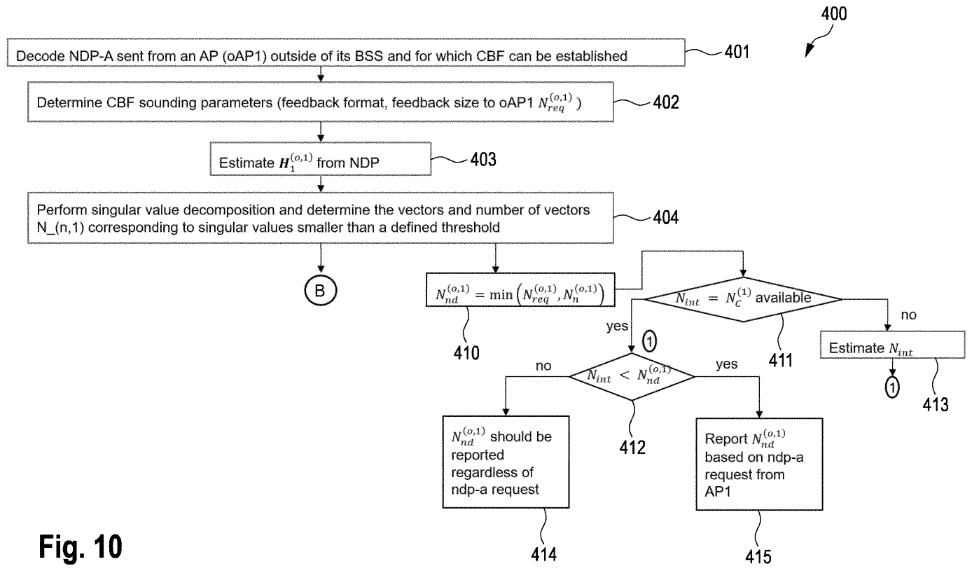

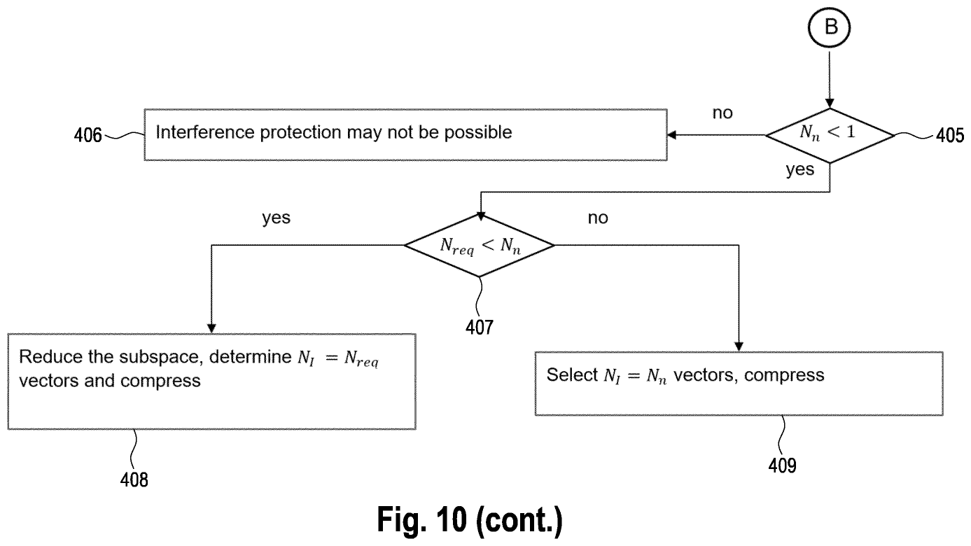

FIG. 10 shows a flow chart of an embodiment of a communication method 400 of an STA (STA1 and oSTA1) according to the present disclosure. As an example, the steps of the communication method are shown for the STA1 for determining the feedback for the oAP1, but the same steps are generally performed by the oSTA1 for determining the feedback for the oAP1. This processing can be combined with the estimation of the channels from AP1 and determination of the feedback to be sent towards AP1.

In a first step 401, NDP-A sent from an AP (oAP1) outside of its BSS and for which CBF can be established is decoded. In a second step 402, CBF sounding parameters (feedback format, feedback size to oAP1

$${N}_{r e q}^{( o , 1 )} )$$

are determined. In a third step 403,

$${H}_{1}^{( o , 1 )}$$

is estimated from NDP. In a fourth step 404, singular value decomposition is performed and the vectors and number of vectors Nom corresponding to singular values smaller than a defined threshold are determined.

Subsequently, different cases are distinguished. In a first case, in step 405 it is checked if Nₙ<1. If no, it is found in step 406 that interference protection may not be possible. If yes, it is checked in step 407 if N_{req}<Nₙ. If yes, in step 408 the subspace is reduced and N_{I}=N_{req} vectors are determined and compressed. If no, in step 409 N₁=Nₙ vectors are selected and compressed.

In a second case, in step

$$410 {N}_{n d}^{( o , 1 )} = min ( {N}_{r e q}^{( o , 1 )} , {N}_{n}^{( o , 1 )} )$$

is set. Subsequently, in step 411 it is checked if

$${N}_{C}^{( 1 )}$$

is available. If yes, Nᵢₙₜ can be assigned to

$${N}_{C}^{( 1 )}$$

and the method proceeds to step 412. If not, Nᵢₙₜ is estimated in step 413 and the method proceeds to step 412. In step 412 it is checked if

$${N}_{i n t} < {N}_{n d}^{( o , 1 )} .$$

If no, in step 414

$${N}_{n d}^{( o , 1 )}$$

should be reported regardless of the NDP-A request. If yes, in step 415

$${N}_{n d}^{( o , 1 )}$$

is reported based on the NDP-A request from AP1.

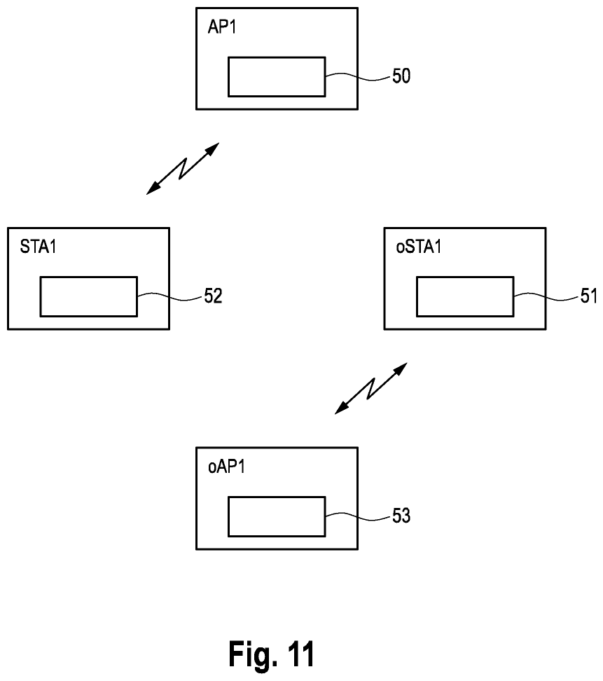

FIG. 11 shows a schematic diagram of an embodiment of a communication system according to an aspect of the present disclosure. The communication system includes a first communication device AP1 for communicating with one (or more) third communication device(s) STA1 and a second communication device oAP1 for communicating with one (or more) fourth communication device(s) oSTA1. According to the present disclosure the two APs AP1, oAP1 are within overlapping basic service sets and engage in partially or fully overlapped downlink transmissions towards the respective associated station(s) STA1, oSTA1. At the same time the interference towards the other stations involved in the coordinated communication scheme is controlled and suppressed/reduced.

Each of the communication devices comprises circuitry 50, 51, 52, 53 that is configured to perform particular operations. The circuitries may be implemented by a respective processor or computer, i.e., as hardware and/or software, or by dedicated units or components. For instance, respectively programmed processors may represent the respective circuitries 50, 51, 52, 53.

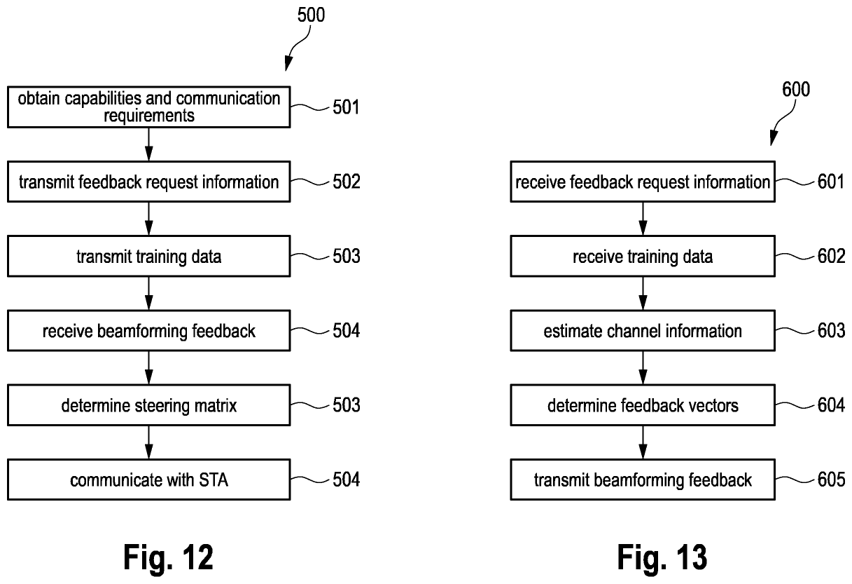

FIG. 12 shows a flow chart of another embodiment of a communication method 500 (also called “first communication method”) of an access point according to the present disclosure, which may be performed by AP1 and oAP1. In the following, the method will be explained when performed by AP1.

In a first (optional) step 501, capabilities and communication requirements of oSTA1 that is configured to communicate with oAP1 in another basic service set. In a second step 502, feedback request information is transmitted to oSTA1 (and optionally STA1). This feedback request information relates to feedback to be fed back by oSTA1 (and optionally STA1) and includes a requested feedback format and a requested number or number range of feedback vectors. In a third step 503, training data are transmitted to oSTA1 (and optionally STA1). In a fourth step 504, beamforming feedback is received from oSTA1 (and optionally STA1) that includes a number of feedback vectors. In a fifth step 505, based on the received beamforming feedback, a steering matrix for communicating with STA1 using beamforming is determined. In a sixth step 506, AP1 communicates with STA1 using the determined steering matrix.

FIG. 13 shows a flow chart of another embodiment of a communication method 600 of a station according to the present disclosure, which may be performed by STA1 and oSTA1. In the following, the method will be explained when performed by oSTA1.

In a first step 601, feedback request information is received from AP1 that is configured to communicate with STA1 in an another basic service set. In a second step 602, training data are received from AP1. from the first communication device. In a third step 603, channel information is estimated based on the received training data. In a fourth step 604, based on the estimated channel information, feedback vectors and a number of feedback vectors corresponding to singular values smaller than an interference threshold are determined. In a fifth step 605, beamforming feedback is transmitted to AP1 in the requested feedback format, the beamforming feedback including the determined feedback vectors.

In summary, a number of aspects are provided by the present disclosure, which include the following aspects for an AP (written from the perspective of oAP1). One or more of these aspects may be used by a communication device and method according to the present disclosure:
oAP1 can determine capabilities and identification of STA within a different BSS (STA1), which can participate in CBF scheme, determines sounding parameters for the training units sent towards STA1, and requests CBF feedback format from STA1.
oAP1 performs sounding with STA from own BSS (oSTA1), wherein as part of the feedback the number of null directions of a channel from different BSS is provide, but participating in the CBF scheme (AP1) towards oSTA1 is requested.
oAP1 requests Vs from STA1 corresponding to SNRs below a threshold or request an indication of the SNR values corresponding to the fed back Vs.
The number of columns of the fed back matrix from STA1 is larger than or equal to the number of spatial streams or maximum number of spatial streams to be used by oAP1 towards oSTA1.
The number of columns to be fed back from STA1 is larger than or equal to the number of interference dimensions that can be controlled at the AP1 and is smaller than or equal to Nₙₛ.
The number of columns of the fed back matrix from STA1 is larger than or equal to the number of spatial streams or the maximum number of spatial streams to be used by AP1 towards STA1 in case of coordination.
The number of columns requested to be fed back in the matrix from oSTA1 may be larger than the maximum number of spatial streams which can be effectively used in communication, to have enough degrees of freedom.
The number of columns is limited by the capabilities of the oSTA1 such as: number of spatial streams it can process during sounding procedure, bandwidth information, whether it can process channel puncturing, whether it can process trigger-based sounding, LTF types that can be used (e.g., 2× or 4×).
The capabilities are informed either directly by the oSTA1 to AP1 or indirectly via oAP1.
The number of columns is indicated in an NDP announcement frame, wherein at least one STA information field for an STA outside of the BSS of AP1 is present. This corresponds to an identifier of the oSTA1, known in both the BSS of AP1 and BSS of oAP1.
The number of LTFs to be used during the transmission of the training data unit (NDP) is not exceeding the maximum number of spatial streams that can be used during the sounding procedure by neither the STA1 nor oSTA1, as signaled in the capabilities of each of these STAs.
The null space is applied to produce a second singular value decomposition of the null space and

$${V}_{o , 1}^{o , 1}$$

and find a steering with N_{nd} dimension in the final SVD decomposition.
From the

$${V}_{1}^{SEL , o , 1}$$

the N_{nd} vectors mostly correlated with the strongest directions of

$${V}_{o , 1}^{( o , 1 )}$$

are fed back by STA 1 to AP1.
STA1 is requested to feed back a beamforming matrix with a number of columns corresponding to the number of receive antennas effectively used by STA1 in the communication with AP1.
A subsequent sounding is performed with oSTA1 in the space determined from the vectors fed back by STA1, which can be performed simultaneously as a subsequent sounding done by AP1 with STA1 in the space determined from the vectors fed back by oSTA1 to AP1.

Generally, each of the communication devices may be implemented by respective units or circuitry, e.g. a processor, processing circuitry, a computer, dedicated hardware, etc., that carries out the functions of the device. Alternatively, a common unit or circuitry, e.g. a common processor or computer, may implement the various functions of the device, or separate units or elements may be used that together represent the circuitry.

Thus, the foregoing discussion discloses and describes merely exemplary embodiments of the present disclosure. As will be understood by those skilled in the art, the present disclosure may be embodied in other specific forms without departing from the spirit or essential characteristics thereof. Accordingly, the disclosure of the present disclosure is intended to be illustrative, but not limiting of the scope of the disclosure, as well as other claims. The disclosure, including any readily discernible variants of the teachings herein, defines, in part, the scope of the foregoing claim terminology such that no inventive subject matter is dedicated to the public.

In the claims, the word “comprising” does not exclude other elements or steps, and the indefinite article “a” or “an” does not exclude a plurality. A single element or other unit may fulfill the functions of several items recited in the claims. The mere fact that certain measures are recited in mutually different dependent claims does not indicate that a combination of these measures cannot be used to advantage.

In so far as embodiments of the disclosure have been described as being implemented, at least in part, by software-controlled data processing apparatus, it will be appreciated that a non-transitory machine-readable medium carrying such software, such as an optical disk, a magnetic disk, semiconductor memory or the like, is also considered to represent an embodiment of the present disclosure. Further, such a software may also be distributed in other forms, such as via the Internet or other wired or wireless telecommunication systems.

The elements of the disclosed devices, apparatus and systems may be implemented by corresponding hardware and/or software elements, for instance appropriate circuits or circuitry. A circuit is a structural assemblage of electronic components including conventional circuit elements, integrated circuits including application specific integrated circuits, standard integrated circuits, application specific standard products, and field programmable gate arrays. Further, a circuit includes central processing units, graphics processing units, and microprocessors which are programmed or configured according to software code. A circuit does not include pure software, although a circuit includes the above-described hardware executing software. A circuit or circuitry may be implemented by a single device or unit or multiple devices or units, or chipset(s), or processor(s).

It follows a list of further embodiments of the disclosed subject-matter:

1. First communication device configured to communicate with one or more third communication devices in its basic service set, the first communication device comprising circuitry configured to
transmit fourth feedback request information to the fourth communication device that is configured to communicate with a second communication device in an another basic service set, the fourth feedback request information relating to feedback to be fed back by the fourth communication device and including a requested feedback format and a requested number or number range of feedback vectors;
transmit fourth training data to at least the fourth communication device;
receive fourth beamforming feedback from the fourth communication device, the fourth beamforming feedback including a number of feedback vectors according to the requested feedback format;
determine, based on the received fourth beamforming feedback, a steering matrix for communicating with the one or more third communication devices using beamforming; and
communicate with the one or more third communication devices using the determined steering matrix.

2. First communication device according to embodiment 1, wherein the circuitry is configured to
transmit third feedback request information and/or third training data to the one or more third communication devices, the third feedback request information relating to feedback to be fed back by the third communication device and including a requested feedback format and a requested number or number range of feedback vectors;
receive third beamforming feedback from the one or more third communication devices; and
determine the steering matrix based on the third and fourth beamforming feedback received from the one or more third communication devices and the fourth communication device.

3. First communication device according to embodiment 2, wherein the circuitry is configured to include in the third feedback request information a requested number of feedback vectors to be fed back by the one or more third communication devices and/or a request to feed back an indication of the number of singular vectors of a channel matrix between the second communication device and the third communication device, corresponding to singular values smaller or equal than a threshold, and/or whether the number of singular vectors determined in this way exceeds the number of feedback vectors requested from the one or more third communication devices.

4. First communication device according to any preceding embodiment, wherein the circuitry is configured to receive the fourth beamforming feedback from the fourth communication device in response to a trigger transmitted to the fourth communication device or within an interframe space time interval from the end of the transmitted training data.

5. First communication device according to any preceding embodiment, wherein the circuitry is configured to determine the requested number of feedback vectors included in the fourth feedback request information to be
larger than or equal to the largest number of directions on which interference can be controlled by the first communication device, and/or
smaller than or equal to the largest null space dimension that can be applied by the first communication device, and/or
larger than or equal to the number of spatial streams that may be used in the communication between the first communication device and a third communication device, and/or
larger than or equal to the number of feedback vectors that the first communication device requests from the third communication device, and/or
larger than or equal to the number of feedback vectors that the second communication device requests from the fourth communication device,
larger than or equal to the number of spatial streams that may be used in the data communication between the second communication device and the fourth communication device, and/or
smaller than or equal to the largest feedback dimension that can be fed back as part of a beamforming feedback to the first communication device.

6. First communication device according to any preceding embodiment, wherein the circuitry is configured to transmit the feedback request information as part of a null data packet announcement.

7. First communication device according to any preceding embodiment, wherein the circuitry is configured to transmit a trigger to the one or more third communication devices and/or the fourth communication device requesting them to transmit beamforming feedback, either directly after the first communication device has transmitted the feedback request information and the training data or after both the first communication device and the second communication device each has subsequently transmitted its feedback request information and its training data.

8. First communication device according to any preceding embodiment, wherein the circuitry is configured to
transmit modified third feedback request information to the one or more third communication devices;
transmit modified third training data to the one or more third communication devices using the determined steering matrix;
receive modified third beamforming feedback from the one or more third communication devices;
determine, based on the received modified third beamforming feedback, a modified steering matrix for communicating with the one or more third communication devices using beamforming; and
communicate with the one or more third communication devices using the modified steering matrix.

9. First communication device according to embodiment 8, wherein the circuitry is configured to
determine a third and fourth beamforming matrix from the third and fourth beamforming feedback;
obtain a first beamforming matrix by multiplying the determined third and fourth beamforming matrices;
obtain a second beamforming matrix by performing a singular value decomposition on the first beamforming matrix;
determining a steering matrix by multiplying the fourth beamforming matrix with the second beamforming matrix or a reshaped second beamforming matrix corresponding to the N_{SS} strongest singular values of the second beamforming matrix, wherein N_{SS} represents the number of spatial streams to be used in the data communication from the first communication device to the one or more third communication devices.

10. First communication device according to embodiment 8, wherein the circuitry is configured to
determine a fourth beamforming matrix from the fourth beamforming feedback;
use as steering matrix the determined fourth beamforming matrix, optionally with a power adjustment.

11. First communication device according to embodiment 8, wherein the circuitry is configured to
determine the third and fourth beamforming matrices based on third and fourth beamforming feedback; and
select from the third beamforming matrix N_{SS} columns corresponding to the vectors which have strongest correlation to the fourth beamforming matrix, wherein N_{SS} represents the number of spatial streams to be used in the data communication from the first communication device to the one or more third communication devices.

12. First communication device according to any preceding embodiment, wherein the circuitry is configured to transmit the modified third training data to the one or more third communication devices simultaneously with a transmission of modified fourth training data from the second communication device to the fourth communication device, wherein the training data are transmitted from the second communication device using a steering matrix determined from the third beamforming feedback requested by the second communication device from one or more third communication devices.

13. First communication device according to any preceding embodiment, wherein the circuitry is configured to obtain, as capabilities and communication requirements of the fourth communication device, one or more of:
identification information for addressing the fourth communication device;
maximum number of spatial streams that can be processed by the fourth communication device for use in determining the requested number or number range of feedback vectors;
bandwidth that can be used by the fourth communication device and within which or part of which sounding should be performed;
information whether puncturing is allowed;
information if compressed long training fields can be used by the fourth communication device;
maximum number of spatial streams which can be received within the sounding; and
maximum supported feedback dimension for the fourth beamforming feedback.

14. First communication device according to any preceding embodiment, wherein the requested feedback format comprises one or more of:
an indication of whether the feedback vectors correspond to a kernel or the null space of a channel between the first communication device and the fourth communication device,
an indication of whether the feedback vectors are compressed or not,
if the feedback vectors are compressed, one or more compression parameters, and
if average signal to noise values shall be included as part of the fourth beamforming feedback.

15. First communication device according to any preceding embodiment, wherein the circuitry is configured to receive, as part of the fourth beamforming feedback:
a number of singular vectors of a channel matrix of a channel between the first communication device and the fourth communication device, the number corresponding to singular values smaller than or equal to a threshold, the number of singular vectors corresponding to the number of requested feedback vectors or in the number range indicated as part of the fourth feedback request information, or
a number of singular vectors of the channel matrix of the channel between the first communication device and the fourth communication device, the number corresponding to all singular values above a threshold or a number corresponding to the number of receive antennas of the fourth communication device or a number corresponding to the maximum supported feedback dimension for the fourth beamforming feedback.

16. First communication device according to any preceding embodiment, wherein the circuitry is configured to transmit third and/or fourth training data including a number of training sequences, which number is smaller than or equal to the number indicated in the capabilities of the third and/or fourth communication device.

17. Fourth communication device configured to communicate with a second communication device in its basic service set, the fourth communication device comprising circuitry configured to
receive fourth feedback request information from a first communication device that is configured to communicate with one or more third communication devices in an another basic service set, the fourth feedback information relating to feedback to be fed back by the fourth communication device to the first communication device and including a requested feedback format and a requested number or number range of feedback vectors;
receive fourth training data from the first communication device;
estimate channel information based on the received fourth training data;
determine, based on the estimated channel information, feedback vectors corresponding to singular vectors of a channel between the first communication device and the fourth communication; and
transmit fourth beamforming feedback to the first communication device according to the requested feedback format, the fourth beamforming feedback including the determined feedback vectors.

18. Fourth communication device according to embodiment 17, wherein the circuitry is configured to determine the interference threshold from an indication received from the first communication device or based on the modulation coding schemes desired by the second communication device or based on a modulation and coding scheme supported by the fourth communication device.

19. Fourth communication device according to any one of embodiments 17 to 18, wherein the circuitry is configured, if the determined number of feedback vectors is smaller than the requested number of feedback vectors or below the number range included in the feedback information, to include in the fourth beamforming feedback a corresponding indication or an indication that interference conditions may not be (or can not be fully) respected.

20. Fourth communication device according to any one of embodiments 17 to 19, wherein the circuitry is configured, if the determined number of feedback vectors is larger than the requested number of feedback vectors or above the number range included in the feedback information, to find a subset of feedback vectors to be fed back.

21. Fourth communication device according to embodiment 20, wherein the fourth beamforming feedback includes a larger number of feedback vectors than the number of spatial streams that can be used in the data communication between the second communication device and the fourth communication device.

22. Fourth communication device according to any one of embodiments 17 to 21, wherein the circuitry is configured to
arrange the determined feedback vectors in decreasing order of the corresponding singular values and include the last of them as feedback vectors in the transmitted fourth beamforming feedback or
choose the determined feedback vectors that are highest correlated with the best channel directions to be used in the communication of the fourth communication device with the second communication device and include them as feedback vectors in the transmitted fourth beamforming feedback.

23. Fourth communication device according to any one of embodiments 17 to 22, wherein the circuitry is configured to
receive further fourth feedback request information and/or further fourth training data from the second communication device; and
transmit further fourth beamforming feedback to the second communication device.

24. Fourth communication device according to any one of embodiments 17 to 23, wherein the circuitry is configured to select from the determined feedback vectors a number of feedback vectors corresponding to one or more of
the requested number or number range included in the fourth feedback request information,
a requested number or number range included in the feedback request information received from the second communication device, and
an estimation of a number of spatial streams that can be used in the data communication of the fourth communication device with the second communication device.

25. Fourth communication device according to any one of embodiments 17 to 24, wherein the circuitry is configured to feed back to the second communication device whether the determined number of singular vectors of the channel between the first communication device and the fourth communication device corresponding to singular values smaller than a threshold or the requested number of feedback vectors included in the fourth feedback request information is smaller than a requested number or number range included in the feedback request information received from the second communication device or an estimation of a number of spatial streams that can be used in the data communication of the fourth communication device with the second communication device.

26. Fourth communication device according to any one of embodiments 17 to 25, wherein the circuitry is configured to select the feedback vectors from the singular vectors of a channel matrix between the first communication device and the fourth communication device that correspond to the singular values smaller than a threshold.

27. Fourth communication device according to any one of embodiments 17 to 26, wherein the circuitry is configured to select the feedback vectors as the singular vectors of a channel matrix between the first communication device and the fourth communication device corresponding to all singular values larger than a threshold or a number of singular vectors equal to the minimum between the number of training fields within the training data transmitted by the first communication device and the number of receive antennas of the fourth communication device.

28. First communication method of a first communication device configured to communicate with one or more third communication devices in its basic service set, the first communication method comprising:
transmitting fourth feedback request information to the fourth communication device, the fourth feedback request information relating to feedback to be fed back by the fourth communication device and including a requested feedback format and a requested number or number range of feedback vectors;
transmitting fourth training data to at least the fourth communication device;
receiving fourth beamforming feedback from the fourth communication device, the fourth beamforming feedback including a number of feedback vectors according to the requested feedback format;
determining, based on the received fourth beamforming feedback, a steering matrix for with communicating the one or more third communication devices using beamforming; and
communicating with the one or more third communication devices using the determined steering matrix.

29. Fourth communication method of a fourth communication device configured to communicate with a second communication device in its basic service set, the fourth communication method comprising:
receiving fourth feedback request information from a first communication device that is configured to communicate with one or more third communication devices in an another basic service set, the fourth feedback information relating to feedback to be fed back by the fourth communication device to the first communication device and including a requested feedback format and a requested number or number range of feedback vectors;
receiving fourth training data from the first communication device;
estimating channel information based on the received fourth training data;
determining, based on the estimated channel information, feedback vectors corresponding to singular vectors of a channel between the first communication device and the fourth communication; and
transmitting fourth beamforming feedback to the first communication device according to the requested feedback format, the fourth beamforming feedback including the determined feedback vectors.

30. A non-transitory computer-readable recording medium that stores therein a computer program product, which, when executed by a processor, causes the method according to embodiment 28 or 29 to be performed.

31. A computer program comprising program code means for causing a computer to perform the steps of said method according to embodiment 28 or 29 when said computer program is carried out on a computer.

1-20. (canceled)

21. A first access point configured to communicate with one or more first stations in its basic service set in a coordinated beamforming scenario, the first access point comprising circuitry configured to:
transmit, as part of a null data packet announcement, feedback request information to the one or more first stations and to a second access point configured to communicate with one or more second stations in another basic service set, the feedback request information including a requested feedback format, a requested number or number range of feedback vectors, and an indication of whether feedback vectors are compressed and, if the feedback vectors are compressed, one or more compression parameters, the null data packet announcement soliciting the second access point to transmit training data to the one or more first stations;
transmit a trigger frame to the one or more first stations, the trigger frame causing the one or more first stations to transmit beamforming feedback in the requested feedback format;
receive the beamforming feedback from the one or more first stations;
determine, based on the received beamforming feedback, a steering matrix for communicating with the one or more first stations using beamforming; and
communicate with the one or more first stations using the determined steering matrix.

22. The first access point of claim 21, wherein the null data packet announcement comprises, for each of the one or more first stations, a respective station information field identifying the first station and indicating a subcarrier grouping, a codebook size, and a number of columns to be used by the first station in generating the beamforming feedback.

23. The first access point of claim 21, wherein the circuitry is configured to, prior to transmitting the null data packet announcement, exchange a coordinated beamforming sounding invite frame and a coordinated beamforming sounding response frame with the second access point to establish the second access point as a responding access point in the coordinated beamforming sounding sequence.

24. The first access point of claim 21, wherein the null data packet announcement is transmitted as part of a cross-basic-service-set coordinated beamforming sounding sequence, and wherein the circuitry is further configured to perform an in-basic-service-set sounding sequence with the one or more first stations to collect additional channel state information from the one or more first stations, the steering matrix being determined based on beamforming feedback received from both the cross-basic-service-set coordinated beamforming sounding sequence and the in-basic-service-set sounding sequence.

25. The first access point of claim 21, wherein the null data packet announcement comprises a first station information field having an access point identifier field set to identify the second access point.

26. The first access point of claim 21, wherein the circuitry is configured to determine the steering matrix by performing a singular value decomposition on a channel matrix derived from the received beamforming feedback and selecting, as the steering matrix, singular vectors corresponding to singular values of the channel matrix.

27. The first access point of claim 21, wherein the trigger frame is a beamforming report poll trigger frame, and wherein the one or more first stations are configured to respond to the trigger frame with a trigger-based physical layer protocol data unit comprising the beamforming feedback.

28. A first access point configured to communicate with one or more first stations in its basic service set in a coordinated beamforming scenario, the first access point comprising circuitry configured to:
transmit, as part of a null data packet announcement, feedback request information to the one or more first stations and to a second access point configured to communicate with one or more second stations in another basic service set, the feedback request information including a requested feedback format, a requested number or number range of feedback vectors, and an indication of whether feedback vectors are compressed and, if the feedback vectors are compressed, one or more compression parameters, the null data packet announcement soliciting the second access point to transmit training data to the one or more first stations and organizing the sounding such that the second access point is informed of the requested feedback format for interpreting the beamforming feedback;
transmit a trigger frame to the one or more first stations, the trigger frame causing the one or more first stations to transmit beamforming feedback in the requested feedback format;
receive the beamforming feedback from the one or more first stations;
determine, based on the received beamforming feedback, a steering matrix for communicating with the one or more first stations using beamforming; and
communicate with the one or more first stations using the determined steering matrix.

29. The first access point of claim 28, wherein the null data packet announcement comprises, for each of the one or more first stations, a respective station information field identifying the first station and indicating a subcarrier grouping, a codebook size, and a number of columns to be used by the first station in generating the beamforming feedback.

30. The first access point of claim 28, wherein the circuitry is configured to, prior to transmitting the null data packet announcement, exchange a coordinated beamforming sounding invite frame and a coordinated beamforming sounding response frame with the second access point to establish the second access point as a responding access point in the coordinated beamforming sounding sequence.

31. The first access point of claim 28, wherein the null data packet announcement comprises a first station information field having an access point identifier field set to identify the second access point.

32. The first access point of claim 28, wherein the circuitry is configured to determine the steering matrix by performing a singular value decomposition on a channel matrix derived from the received beamforming feedback and selecting, as the steering matrix, singular vectors corresponding to singular values of the channel matrix.

33. The first access point of claim 28, wherein the trigger frame is a beamforming report poll trigger frame, and wherein the one or more first stations are configured to respond to the trigger frame with a trigger-based physical layer protocol data unit comprising the beamforming feedback.

34. A communication method of a first access point configured to communicate with one or more first stations in its basic service set in a coordinated beamforming scenario, the method comprising:
transmitting, as part of a null data packet announcement, feedback request information to the one or more first stations and to a second access point configured to communicate with one or more second stations in another basic service set, the feedback request information including a requested feedback format, a requested number or number range of feedback vectors, and an indication of whether feedback vectors are compressed and, if the feedback vectors are compressed, one or more compression parameters, the null data packet announcement soliciting the second access point to transmit training data to the one or more first stations;
transmitting a trigger frame to the one or more first stations, the trigger frame causing the one or more first stations to transmit beamforming feedback in the requested feedback format;
receiving the beamforming feedback from the one or more first stations;
determining, based on the received beamforming feedback, a steering matrix for communicating with the one or more first stations using beamforming; and
communicating with the one or more first stations using the determined steering matrix.

35. The method of claim 34, wherein the null data packet announcement comprises, for each of the one or more first stations, a respective station information field identifying the first station and indicating a subcarrier grouping, a codebook size, and a number of columns to be used by the first station in generating the beamforming feedback.

36. The method of claim 34, further comprising, prior to the transmitting of the null data packet announcement, exchanging a coordinated beamforming sounding invite frame and a coordinated beamforming sounding response frame with the second access point to establish the second access point as a responding access point in the coordinated beamforming sounding sequence.

37. The method of claim 34, wherein the determining of the steering matrix comprises performing a singular value decomposition on a channel matrix derived from the received beamforming feedback and selecting, as the steering matrix, singular vectors corresponding to singular values of the channel matrix.

38. The method of claim 34, wherein the null data packet announcement is transmitted as part of a cross-basic-service-set coordinated beamforming sounding sequence, the method further comprising performing an in-basic-service-set sounding sequence with the one or more first stations to collect additional channel state information from the one or more first stations, wherein the steering matrix is determined based on beamforming feedback received from both the cross-basic-service-set coordinated beamforming sounding sequence and the in-basic-service-set sounding sequence.

39. The method of claim 34, wherein the trigger frame is a beamforming report poll trigger frame, and wherein the one or more first stations respond to the trigger frame with a trigger-based physical layer protocol data unit comprising the beamforming feedback.

40. A non-transitory computer-readable recording medium storing a computer program which, when executed by a processor of a first access point, causes the first access point to perform the method of claim 34.
